(19) United States
(12) Patent Application Publication
(10) Pub. No.: US 2024/0410616 A1
(43) Pub. Date: Dec. 12, 2024

(54) ELECTRIC STOVE

(71) Applicant: PAUL WURTH S.A., Luxembourg (LU)

(72) Inventors: Andrea CASTELLI, Genoa (IT); Federico GAROFALO, Savona (IT); Davide BRUNI, Genoa (IT)

(21) Appl. No.: 18/695,051

(22) PCT Filed: Sep. 22, 2022
(86) PCT No.: PCT/EP2022/076313

§ 371 Date: Mar. 25, 2024

(30) Foreign Application Priority Data
Sep. 24, 2021 (LU) 500686

(51) Int. Cl. F24H 3/04; F27D 1/00

(52) U.S. Cl. CPC F24H 3/0405; F27D 1/0036; F24H 2250/02

(57) ABSTRACT

Electric stove for heating a reducing gas, the electric stove including: a hollow metal shell body extending along a longitudinal direction; a refractory lining arranged on an inner surface portion of the shell body; a plurality of bricks arranged in adjacent layers extending along the longitudinal direction, where each brick includes a plurality of cavities extending straight along the longitudinal direction through the respective layer, where the cavities of adjacent layers are aligned to one another, whereby a plurality of channels for conducting the reducing gas is formed; and a plurality of heating wires for heating the reducing gas, wherein each heating wire has a diameter smaller than a diameter of a channel, and where each heating wire extends at least partially through at least one corresponding channel of the plurality of channels, such that when the electric stove is operated, a predefined heat amount is dissipated by each heating wire to a reducing gas flowing around the heating wire.

### TECHNICAL FIELD

The disclosure relates to an electric stove and in particular to an electric stove for heating a reducing gas to be injected in metallurgical furnaces.

### BACKGROUND

According to recent developments in the metallurgic industry, steel producers aim to reduce the amount of green-house gas emissions which are considered environmentally harmful, such as e.g. carbon dioxide. As a result, steel producers target for using “green” (electric) energy sources in the production of metallurgical products. Indeed, future steel production will most likely focus on the use of low carbon production methods in combination with the usage of sustainable energy sources. In this context, also the use of direct reduction processes based on reducing gases comprising H₂ and/or syngas is envisaged.

In prior art, fired heaters and regenerative heat exchangers (such as hot blast stoves) are known for heating up process gasses on industrial scale. However, these heaters require the combustion of fuels. In addition, most apparatus available on the market fed by electric energy do not seem suitable to heat up reducing gases at a sufficient temperature or are not responding to “heavy” industry requirements. For example, a majority of these apparatus is not scalable to the multi-MW size required for processing large volumes of gas. In addition, most apparatus are unsuited to heat-up a dusty gas (i.e. a gas containing between 0 mg and 5 mg of solids/Nm³). Therefore, no known apparatus responds to the requirements for electric heating of gas in terms of flow-rate, power scale, dust content, output temperature or other specific layout requirements. It is thus desirable to provide a solution for overcoming these drawbacks.

### BRIEF SUMMARY

The present disclosure provides a heater that is configured or suitable to heat up a gas at an industrial scale. This is achieved by an electric stove, as defined herein.

The proposed electric stove configured or suitable for heating a (reducing) gas comprises a hollow metal shell body extending along a longitudinal direction, a refractory lining arranged within the shell body, and a plurality of bricks arranged in adjacent layers extending along the longitudinal direction. Each brick comprises a plurality of cavities extending straight along the longitudinal direction through the respective layer. The cavities of adjacent layers are aligned to one another, whereby a plurality of channels for conducting the (reducing) gas is formed. The electric stove comprises further a plurality of heating wires for heating the (reducing) gas, wherein heating wire has a diameter smaller than a diameter of a channel. Each heating wire extends at least partially through at least one corresponding channel of the plurality of channels, such that when the electric stove is operated, a predefined heat amount is dissipated by each heating wire to a reducing gas flowing around said heating wire.

It had been found that the proposed arrangement allows to provide a heating stove for heating a (reducing) gas having a particularly compact design, which in turn permits a space saving installation on industrial premises. It had been further found, that the current arrangement is also scalable in case of necessity and/or if a specific amount of (reducing) gas has to be heated.

The proposed arrangement also opens the possibility of introducing gas with other compounds, such as for example gases containing dust. There are e.g. no known devices in the prior art that permit the heating of a reduction gas containing dust. In order for a dust-containing gas flowing through the bricks to be heated in the stove, it is necessary to ensure a certain minimum size of the cavities.

In addition, the proposed arrangement may be operated in particular in direct reduced iron (DRI) production and/or (blast) furnace plants having a syngas injection system. As a result, the proposed arrangement allows heating up process gases based on sustainable (e.g. “green”) energy sources, whereby traditional fuel-based systems may be replaced. The negative environmental impacts caused by classical heaters may thus be significantly reduced.

“Reducing gas” may generally refer to any chemical medium having a reducing property. For example, a reducing gas may be a gas comprising hydrogen and/or carbon monoxide, respectively a syngas. Apart from that, it should be noted that the electric stove is not limited to the processing of reducing gases only. Other gases, in particular process gases, for different industrial processes can also be heated, such as, e.g., CO₂, CO, N₂, O₂, H₂O, H₂, etc.

“Hollow metal shell body” may generally refer to the frame or reservoir of an equipment or a reactor in which the (reducing) gas is heated.

“Longitudinal direction” may generally refer to the main length direction along which the shell body extends. In other words, the longitudinal direction may be defined by a direction along which the electric stove extends. For example, when the electric stove is installed horizontally, the longitudinal direction may be parallel to a horizontal direction or a horizontal plane, such as e.g. the ground.

“Refractory lining” may generally refer to one or more layers of a high-temperature resistant material, such as refractory bricks. The refractory lining may at least be arranged on a portion or the entire inner surface of the shell body. Alternatively, one or more layers of an insulating lining may be arranged between the refractory lining and the steel shell, wherein the insulating lining may comprise a layer of insulating bricks and a layer of castable ceramics. Further for the refractory lining may comprise one or more layers of different bricks having insulating and/or isolating properties. It should be noted that the refractory lining may in general be selected based on working temperature, which might also allow the use of different materials along the heater length, respectively the longitudinal direction. In particular, the refractory material may comprise various grades of high alumina refractories, which do not tend to react to hydrogen. The bricks of the refractory lining may be specifically formed to support the plurality of bricks, respectively checker bricks, that conduct the heating wires.

“Plurality of bricks” may generally refer to an amount of checker bricks or similar brick-like elements. Each brick may comprise a plurality of cavities, respectively through-holes or apertures. The cavities may have a circular or semi-circular shape. Additionally, or alternatively, each brick may also comprise so called “semi-cavities” which are arranged at an edge portion of a brick and which represent a half of the shape of an entire cavity. Two semi-cavities, or half-cavities, of two adjacent bricks may be used to form an entire cavity. It is understood, that the cavities may also have other shapes. All cavities may extend along a direction parallel to the longitudinal direction. Due to this configuration, the cavities of neighboring bricks of adjacent layers may be aligned to one another, whereby a plurality of channels for conducting the (reducing) gas is formed. In this context, “channel” generally refers to a straight passage extending through several brick layers, wherein the channel is formed of adjacently arranged cavities and/or semi-cavities.

“Layer” may generally refer to a course, respectively a level, respectively a structure, comprising a predefined amount of bricks, wherein the bricks defining the structure are affiliated with each other. It is understood that the layers may have an identical length along the longitudinal direction. However, there may be embodiments wherein the layers have different lengths.

“Plurality of heating wires” generally refers to a metal thread or rod that is configured for heating by means of an electrical conduction. The wires may be arranged within the channels formed by the bricks. The heating wire may thus preferably have a diameter smaller than a diameter of a channel or a diameter of a cavity. Due to this arrangement, the gas may flow substantially around a wire. Each heating wire extends at least partially through at least one channel of the plurality of channels, such that when the electric stove is operated, a predefined heat amount is dissipated by each heating wire to the (reducing) gas flowing around said heating wire. In this context, it should be noted that the heating wire material may be chosen among a wide range of materials. In particular, the wire material may be apt to withstand the high temperature and/or a reaction with (a) component(s) of the process gases, respectively the reducing gases. For example, it is known that a wire's lifetime gets shorter when the wire is often brought in contact with a gas having a high nitrogen concentration. The nitrogen content within (reducing) gases may yet be kept low (≤10%), and the maximum gas temperature may be kept in a range 800°° C. to 1000° C., preferably 900° C. Apart from that, the plurality of heating wires may be also be configured to be operated at other temperatures, for example lower temperatures.

In an embodiment, each of at least two adjacent bricks within a corresponding layer is provided with a semi-cavity, and the at least two adjacent bricks are aligned to each other such that the semi-cavities of the respective bricks form an entire cavity. The semi-cavity may be arranged in an edge area of a brick.

“Corresponding layer” may generally refer to a layer, wherein two bricks having a semi-cavity on an edge area are arranged next to each other, such that the two semi-cavities form an aperture corresponding to a cavity. By arranging semi-cavities, an efficient use of space within the shell body may be achieved.

In an embodiment, the diameter of a channel is between more than 1 to 5 times larger than the diameter of the heating wire. A channel having a diameter larger than the diameter of the heating wire allows dusty gas to be heated efficiently and without risk of clogging the channels by dust that may have settled in the channels. A gap between the wire and the refractory lining may thus have a size within a range of 4 millimeters to 40 millimeters.

In an embodiment, an insulating lining is arranged between a portion of an inner surface of the metal shell body and the refractory lining. The insulating lining may comprise one or more layers of an insulating material or insulating construction elements. For example, the insulating lining may comprise a first layer of insulating castable ceramic and a second layer of refractory bricks.

In an embodiment, the electric stove has a gas inlet in fluid communication to a distribution ring, wherein the distribution ring comprises a plurality of supply ports configured to conduct a (reducing) gas into a first end portion of the shell body; and wherein the electric stove has a gas outlet at a second end portion of the shell body, wherein the gas outlet extends along the longitudinal direction. The term “end portion” refers to an extremity of the shell body. By arranging a distribution ring at the first end portion, the incoming gas to be heated is evenly distributed and guided into the channels. In alternative embodiments, for example in embodiments of smaller dimensioning, the installation of a distribution ring may not be necessary.

In an embodiment, one or more or each electric heating wire of the plurality of heating wires has a U-shaped portion arranged opposite to or at the gas outlet. “U-shaped” generally refers to a form of a wire section, i.e. a form that allows to connect two parallel extending wires with one another. By providing U-shaped portions, which may be integral with the wire or which may alternatively be applied/arranged to it, it is possible to provide an electric contact module at only one location, preferably a location near the gas inlet within the shell body. This ensures that an electrical contact module is not exposed to the rather high temperatures of the heated gas near the gas outlet. The U-shaped portion is thus preferably arranged opposite to or at the gas outlet. The term “opposite to” in this context means, that an apex of the U-shaped portion may face in the direction of the gas outlet. The term “at” in this context means, that the U-shaped portion may be arranged in direct vicinity to the gas outlet.

In an embodiment, the plurality of electric heating wires is arranged in series and/or in parallel. Since the arrangement may be connected in series and/or in parallel, the most suitable electric resistance may be built up, such that a proper Joule Effect may be achieved.

In an embodiment, the electric stove is configured to be operated on low voltage by one of: a single-phase alternate current, a three-phase alternate current, or a direct current. In particular three-phase or single-phase alternate current may be easily available from the electric distribution network. Alternatively, a proper design with direct current may be arranged. In cases direct current is used, a dedicated equipment may be provided upstream the electric stoves to transform the alternate current from the network into direct current.

In an embodiment, the electric stove further comprises centering elements to keep the electrical heating wires from touching the walls of the channel in which they are located. Each channel may comprise one or more such centering elements which may preferably spaced apart from one another in a longitudinal direction by, e.g., 25 cm to 150 cm. It should be noted that the centering elements may alternatively by spaced apart more closely to one another or even more fare away from one another.

The term “centering element” refers to an element which might have a brick-like structure, except for the cavity, respectively the semi-cavity. The cavity of a centering element and/or the semi-cavity of the centering element may have a different form than the cavity of the brick, respectively the semi-cavity of a brick. For example, the cavity of the centering element may have a pin, protrusion, projection, a bulge or the like on which the electrical heating rests while at the same time restricting the channel as little as possible. Alternatively, the cavity of the centering element may have a circular shape that has a slightly smaller diameter than the diameter of a cavity of a brick. Due to the centering elements, the heating wire may be held at a substantially central position of a channel. Alternatively, the term “centering element” may also refer to a device arranged on the wire, wherein said device supports and centers the wire with respect to the wall of a channel. In this case, the centering element may be an element made of one of the following: a metal, a plastic, a resin, or mixtures thereof. The centering elements prevents an excessive bending and/or a creep deformation of the wire by ensuring proper support. As a result, a uniform cooling of the wire may be performed. As a further result, the generation of hot spots may be prevented, such that the lifetime of the wire is significantly extended. It should be noted that centering elements may have a high electric resistance be chosen from and/or comprise highly electric resistant materials to avoid short-circuit among wires in adjacent cavities.

In embodiments, the shell body has a diameter in a range of 0.5 m to 4 m, preferably in a range of 1.50 m to 2.50 m, most preferred of 2 m; and wherein the shell body has a length within a range of 5 m to 12 m, preferably in a range of 6 m to 10 m, most preferred of 7 m. The dimensions of the shell body may be adjusted to the requirements by scaling.

In embodiments, the electric stove further comprises an electric connection module for providing electric contacts to the electric heating wires, wherein the electric connection module is arranged at the first end section in vicinity to the plurality of supply ports and spaced apart from the layers. By placing the electric connection module at the colder end of the shell body, the temperature load on the electric connection module is kept comparatively low, which may lead to an extended service life.

In embodiments, the shell body of the electric stove is arranged horizontally with respect to the ground. “Arranged horizontally” refers to an arrangement wherein the shell and/or a central axis of the shell body extends along a direction parallel to the ground. A horizontal arrangement may avoid the need for a heavy support structure. A horizontally arranged stove may also be easily accessible for operators. In alternative embodiments, the electrical stove may be arranged vertically, wherein the vertical arrangement allows a comparatively space-saving installation. The term “horizontally” may also refer to a direction or plane that is parallel to the longitudinal direction.

In embodiments, the shell body is configured to accommodate a pressurized (reducing) gas, wherein the maximum pressure supported by the shell body is in a range of 0.0 bar (g) to 5.0 bar (g), preferably 1.5 bar to 4.0 bar (g), most preferred 3.6 bar (g). The width of the shell may be in a range defined according to the applied pressures.

In embodiments, the shell body comprises one of the following: a carbon steel, a coating, a chromium-based alloy, or mixtures thereof. For example, the carbon steel may be a steel such as AISI 316 L. The coating and the chromium-based alloy may prevent hydrogen embrittlement as well as metal dusting, which would otherwise occur in presence of CO/CO₂ or carbon compounds at high temperatures.

### BRIEF DESCRIPTION OF THE DRAWINGS

Embodiments of the disclosure are now described by way of examples and with reference to the attached drawings, wherein:

FIG. 1: is a schematic perspective view of an embodiment of the electric stove;

FIG. 2: is a schematic, transparent perspective view of an embodiment of the electric stove;

FIG. 2A: is an enlargement of a section of FIG. 2;

FIG. 3: is a schematic view of a plurality of wires extending along the channels of the bricks arranged opposite the gas outlet;

FIG. 4: is a schematic sectional view of an embodiment of the electric stove comprising centering elements.

### DESCRIPTION OF EMBODIMENTS

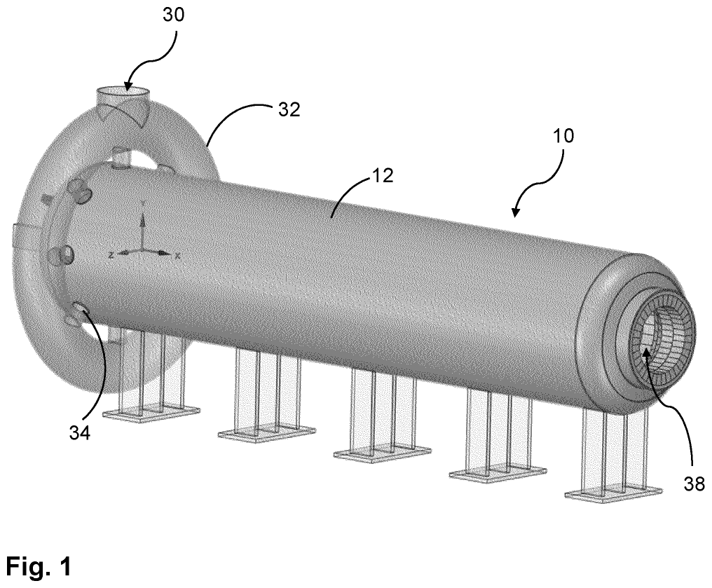

With reference to FIG. 1, an embodiment of an electric stove 10 is illustrated. The electric stove 10 comprises a hollow metal body, respectively shell 12, made of steel extending along a longitudinal direction X. The electric stove 10 is arranged horizontally with respect to the ground, which may be referred to as a plane defined by the longitudinal direction X and the width direction Z.

Due to its horizontal arrangement, an internal supporting structure for refractories is not required. As a consequence, the risk of short circuits with the electric connection module is avoided due to the horizontal arrangement, which is due to the fact that a dedicated refractory supporting structure is not needed. In contrast, a vertical arrangement (not shown) would require that the refractory supporting structure and the electric connection module would share the same space inside the stove, respectively the equipment, which more prone to shortcuts.

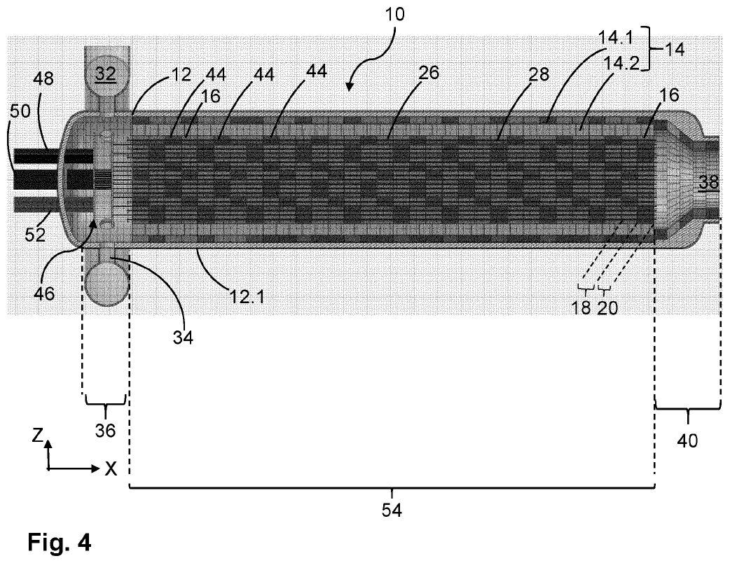

The electric stove 10 has a gas inlet 30 in fluid communication to a distribution ring 32, wherein the distribution ring 32 comprises a plurality of supply ports 34 configured to conduct a (reducing) gas into a first end portion 36 of the shell body 12, which can be seen best in FIG. 4. The support ports 34 are concentrically arranged with respect to a shell axis extending along the longitudinal direction X. A gas outlet 38 also extending along the shell axis is arranged at an opposed second end portion 40 of the shell body 12.

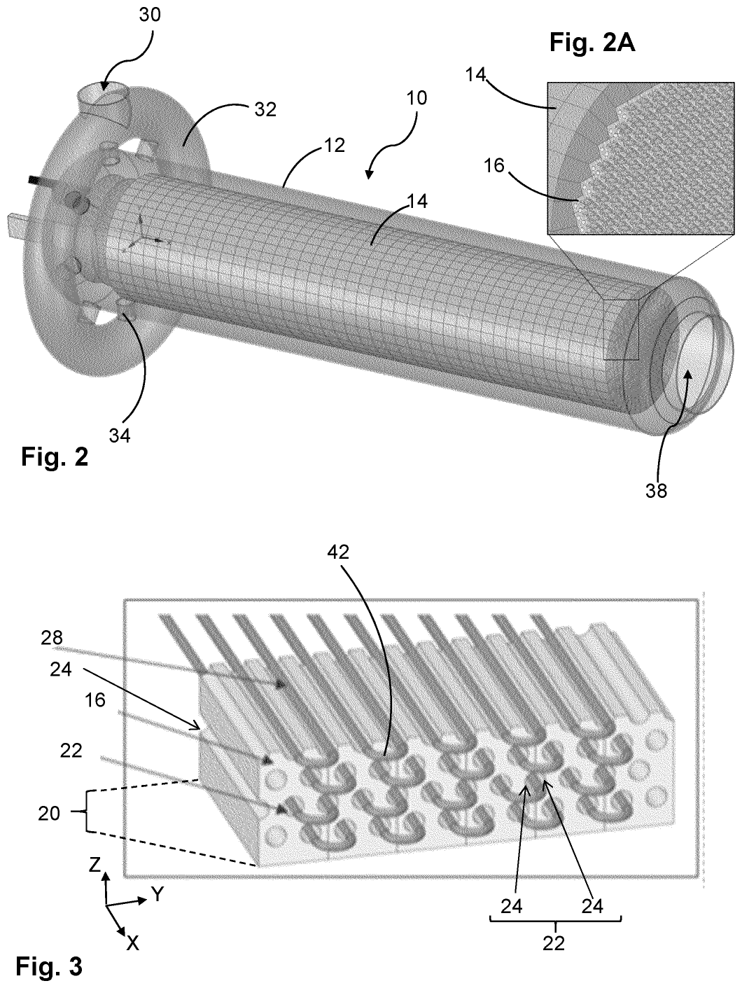

As can be seen in FIG. 2 and FIG. 4, a plurality of bricks 16 is arranged in adjacent layers 18, 20 extending along the longitudinal direction X.

The insulating lining 14 is provided at an inner surface of the shell body 12. The insulating lining 14 is formed by two layers of insulation lining 14.1 and 14.2. The first layer 14.1 of insulation lining 14 is formed of castable ceramics and is arranged on the inner surface of the steel shell 12. The second layer 14.2 of the insulation lining 14 is arranged on the first layer 14.1 and is formed of refractory bricks 14.2. As can be derived from FIG. 4, a further layer of special shaped refractory lining 15 is arranged between the bricks 16 and the insulating lining 14. The refractory lining 15 comprises also several of refractory bricks 15.1, wherein the refractory lining 15 is arranged and formed in such a way, that it allows the insertion of the formed bricks 16 at the center of the steel shell 12. In other words, the refractory lining 15 supports the rectangular bricks 16. It should be noted that FIGS. 2 and 2A merely illustrate the layer of the refractory lining 15 in a transparently illustrated shell 12, for the purpose of better understanding. The embodiment shown in FIG. 4 illustrates both layers 14.1 and 14.2 of the insulating lining 14 as well as the layer of the refractory bricks 15.

As illustrated in FIG. 4, the bricks 15.1 of the special shaped refractory lining 15 are not aligned with the layers of the bricks 16 along the longitudinal direction X, as can be seen for example in the embodiment illustrated by FIG. 4. It should be noted however, that in alternative embodiments, the layer refractory bricks 15.1 may be flush with the layers of the bricks 16 in the longitudinal direction.

As illustrated in FIG. 3, each brick 16 comprises a plurality of cavities 22 and semi-cavities 24 extending straight along the longitudinal direction X through a respective layer 20. The bricks 16 illustrated in FIG. 3 form part of the outmost layer 20 opposite of the gas outlet 38. The cavities 22 and semi-cavities 24 of the different bricks 16 are aligned with one another with respect to the cavities 22 and semi-cavities 24 of the bricks of a neighboring layer 18 (not shown), such that the cavities 22 and semi-cavities 24 form channels 26 extending through the different layers 18, 20 as shown in FIG. 4. In other words, the bricks 16 form clear straight paths parallel to one another along the longitudinal direction X. In addition, since the semi-cavities 24 are arranged at an edge area of each brick 16, adjacent bricks 16 within the same layer 18, 20 may be aligned to each other in such a way that their respective semi-cavities 24, 24 form an entire cavity 22, which is also illustrated in FIG. 3.

As can be seen in FIG. 3, a plurality of heating wires 28 is conducted through the cavities 22 and semi-cavities 24 of the bricks 16. Each wire 28 has a diameter smaller than a diameter of a cavity 22, respectively the channel 26. In other words, a single wire 28 is placed within a cavity 22. Each electric heating wire 28 of the plurality of heating wires has a U-shaped portion 42 arranged opposite the gas outlet 38. Due to this arrangement, a single wire 28 may traverse two adjacently arranged channels 26. Therefore, a wire 28 extends at least partially through a corresponding channel 26, respectively the cavities 24 and semi-cavities 26 forming the channels 26. When the electric stove is operated, the wires 28 dissipate a predefined amount of heat energy whilst being in contact with the (reducing) gas. This arrangement ensures a quick cooling of the heating wire 28, even at wire sections near to or arranged at a direct vicinity of the gas outlet.

FIG. 4 illustrates an embodiment of the electric stove 10 comprising centering elements 44. The centering elements 44 have a structure similar to the structure of the bricks 16, except for the geometry of the cavity (not shown), which is smaller in comparison to the cavities 22 of the bricks. For this reason, the wire 28 rests in a substantially centered position within the channel 26. As a consequence, the heat dissipated by the wire 28 is evenly distributed to the gas flowing around the wire 28. The centering elements 44 are spaced apart from one another by several layers of bricks 16. In other words, the positioning of the centering elements may be considered to represent a regular pattern within a matrix-like structure formed by the layers of bricks 16. For this reason, the centering elements 44 are spaced apart from one another at a predefined distance.

FIG. 4 also illustrates schematically the inner structure of the electric stove 10. The steel shell is referred to reference sign 12. In addition, the refractory lining 15 comprising refractory bricks 15.1 is arranged adjacently to the insulation lining 14. The refractory lining bricks 15.1 are specifically shaped to provide the arrangement of the rectangular bricks 16 having cavities 22, 24 inside the cylindrical equipment, respectively the cylindrical shell 12. It should be noted that the cylindrical shape allows to distribute the stress coming from the internal pressure more evenly.

Between the first end portion 36 and the second end portion 40, a middle portion 54 extends. The middle portion 54 comprises different layers 18, 20 of the bricks 16.

Both layers 14.1 and 14.2 of the insulation lining 14 arranged underneath the surface of the shell 12 extend along the middle portion 54 and the second end portion 40. In the embodiments shown in FIG. 4, the refractory lining 15 extends merely along the middle portion 54, since the end portions 36, 40 do not require wire guiding bricks 16, no refractory lining 15 supporting said bricks 16 is required said end portions 36, 40. The insulating lining 14 as well as the refractory lining 15 may comprise materials based on aluminum compounds.

In the embodiment shown in FIG. 4, the first end portion 32 is not equipped with the full insulation lining 14, but merely with the first layer of insulation lining 14.1, which is due to the fact that the temperature is lower at the first end portion, such that less insulation is required.

As can be further derived from FIG. 4, the electric stove 10 also comprises an electric connection module 46 for providing electric contacts to the electric heating wires 28. In the embodiment shown in FIG. 4, the electric connection module 46 is connected to a three-phase current-carrying cable connection, which comprises three cores 48, 50, 52. The electric connection module 46 is placed within the first end portion 36 in vicinity to the plurality of supply ports 34. By arranging the connection module 46 at the first end portion 36, sufficient space is provided between the electric connection module 46 and the different layers of bricks. In other words, the electric connection module 46 is placed outside the matrix-like structure formed by the layers of bricks 16. In this area, the heat transfer is less effective compared to the channels within the matrix-like structure. The support ports 34 for the letting in the pressurized gas are arranged radially around a central longitudinal axis (along the longitudinal direction X) of the shell 12, which allows to avoid the appearance of preferential/neglected areas leading to hot and/or cold areas. The gas outlet 38 on the other hand is arranged around the longitudinal axis.

Each of the electric stoves 10 shown in FIGS. 1 to 4 is configured to be operated at a power range of approximately 25 MWₜ. In the illustrated embodiments, the electric stove has approximately a length of 10 m and a diameter of 2 m. The equipment features, respectively the components of the electric stove, are configurable so that power range can be scaled up/down.

The discussed embodiments are examples of the disclosure. In the case of the embodiments, the described components of the respective embodiment each represent individual features of the disclosure which are to be considered independently of each other and which also further develop the disclosure independently of each other. The features are thus also to be regarded as components of the disclosure individually or in a combination other than the combination shown. Furthermore, the described embodiments can also be supplemented by further features of the disclosure already described. Further features and embodiments of the disclosure result for the skilled person in the context of the present disclosure and the claims.

1. Electric stove for heating a reducing gas, the electric stove comprising:
a hollow metal shell body extending along a longitudinal direction;
a refractory lining arranged within the shell body;
a plurality of bricks arranged in adjacent layers extending along the longitudinal direction, wherein each brick comprises a plurality of cavities extending straight along the longitudinal direction through the respective layer, wherein the cavities of adjacent layers are aligned to one another, whereby a plurality of channels having a diameter for conducting the reducing gas is formed; and
a plurality of heating wires for heating the reducing gas, wherein each heating wire has a diameter smaller than the diameter of a channel, and wherein each heating wire extends at least partially through at least one corresponding channel of the plurality of channels, such that when the electric stove is operated, a predefined heat amount is dissipated by each heating wire to a reducing gas flowing around said heating wire.

2. The electric stove according to claim 1, wherein each of at least two adjacent bricks within a corresponding layer is provided with a semi-cavity, and wherein the at least two adjacent bricks are aligned to each other such that the semi-cavities of the respective bricks form an entire cavity.

3. The electric stove according to claim 1, wherein a diameter of a channel is between more than 1 to 5 times larger than a diameter of the heating wire.

4. The electric stove according to claim 1, wherein an insulating lining is arranged between a portion of an inner surface of the metal shell body and the refractory lining.

5. The electric stove according to claim 1, wherein the electric stove has a gas inlet in fluid communication to a distribution ring, wherein the distribution ring comprises a plurality of supply ports configured to conduct the reducing gas into a first end portion of the shell body; and wherein the electric stove has a gas outlet at a second end portion of the shell body, wherein the gas outlet extends along the longitudinal direction.

6. The electric stove according to claim 5, wherein each electric heating wire of the plurality of heating wires has a U-shaped portion arranged opposite or at to the gas outlet.

7. The electric stove according to claim 1, wherein the plurality of electric heating wires is arranged in series and/or in parallel.

8. The electric stove according to claim 1, wherein the electric stove is configured to be operated on low voltage by one of: a single-phase alternate current, a three-phase alternate current, or a direct current.

9. The electric stove according to claim 1, wherein the electric stove further comprises centering elements, wherein centering elements forming part of the same channel are aligned to one another along the longitudinal direction in spaced apart layers, whereby the centering elements are located at specific distances from one another.

10. The electric stove according to claim 1, wherein the shell body has a diameter in a range of 0.5 m to 4 m; and wherein the shell body has a length within a range of 5 m to 12 m.

11. The electric stove according to claim 5, wherein the electric stove further comprises an electric connection module for providing electric contacts to the electric heating wires, and wherein the electric connection module is arranged at the first end portion in vicinity to the plurality of supply ports and spaced apart from the layers.

12. The electric stove according to claim 1, wherein the shell body of the electric stove is arranged horizontally with respect to ground.

13. The electric stove according to claim 1, wherein the shell body is configured to accommodate pressurized reducing gas, wherein the maximum pressure supported by the shell body is in a range in a range of 0.0 bar gauge to 5.0 bar gauge.

14. The electric stove according to claim 1, wherein the shell body comprises one of the following: a carbon steel, a coating, a chromium-based alloy, or mixtures thereof.
